(19) United States
(12) Patent Application Publication
(10) Pub. No.: US 2026/0021704 A1
(43) Pub. Date: Jan. 22, 2026

(54) Electric Generation System for Vehicle

(71) Applicant: James R. Tibbetts, JR., Middleboro, MA (US)

(72) Inventor: James R. Tibbetts, JR., Middleboro, MA (US)

(21) Appl. No.: 18/777,602

(22) Filed: Jul. 19, 2024

(51) Int. Cl. B60L 1/00; H02K 7/18

(52) U.S. Cl. CPC B60L 1/006; H02K 7/1846; B60L 2200/28

(57) ABSTRACT

A vehicle power generation system is provided. The system may be mounted to a trailer to generate electricity for use in powering vehicle or trailer electrical systems, charging batteries on the trailer or vehicle pulling it, and the like. Other embodiments include direct mounting of the power generation system on the vehicle itself.

### BACKGROUND OF THE INVENTION

The present disclosure relates generally to an electric generation system for a vehicle. More particularly, the present disclosure relates to a system that generates electricity by movement of a wheel or wheels, such as on a trailer, while the wheel is rotating.

With the proliferation of electric vehicles and other electrically powered machines and equipment, the need for electrical generation and sources of electricity are also growing rapidly. Indeed, when in remote locations, electrically powered vehicles, machines, and devices can rapidly be rendered useless. This is a problem not only for electric vehicle drivers, but also many professionals and workers who require electrical power in remote areas such as job sites, and the like.

Electric vehicles struggle when pulling trailers—and their range is drastically reduced. This is due to the added drag from the trailer, combined with the highly efficient electric motors which consume only the power required, rather than internal combustion engines (“ICE”) which often operate with power to spare-making the added trailer load less noticeable. Further, there is a meaningful amount of excess energy on rotating wheels that can be captured on a trailer as it is being pulled, as well as when braking and going downhill.

Therefore, what is needed is an electrical generation system which is able to generate accessible electricity from kinetic energy.

### SUMMARY OF THE INVENTION

The subject matter of this application may involve, in some cases, interrelated products, alternative solutions to a particular problem, and/or a plurality of different uses of a single system or article.

In one aspect, an electric vehicle and trailer assembly is provided. The assembly includes an electric vehicle (such as a car, truck, SUV, crossover vehicle, and the like) having a primary battery operable to provide power to an electric drive motor; and a fuse panel controlling power to vehicle accessory electronic systems, along with a trailer connected to the vehicle. The trailer comprises an axle having two hubs, and a wheel connected to each hub, a trailer body, and an alternator connected to the trailer and engaged with at least one of the axle, two hubs, and wheel or wheels. The alternator is operable to generate electricity upon a rotation of at least one of the axle, two hubs, and wheel or wheels. This alternator is in electric communication with at least one of the fuse panel and the primary battery of the vehicle to provide electrical power to at least one of the fuse panel and the primary battery. Leading to increased efficiency and improved range and convenient electric power accessibility.

In another aspect, an electric vehicle is provided. The electric vehicle having a primary battery operable to provide power to an electric drive motor; and a fuse panel controlling power to vehicle accessory electronic systems. The vehicle further has an alternator engaged with at least one of an axle, two hubs, and wheel or wheels of the electric vehicle. The alternator is operable to generate electricity upon a rotation of at least one of the axle, two hubs, and wheel or wheels, is in electric communication with the fuse panel provide electrical power to the fuse panel to provide power to the use panel to provide electricity to onboard vehicle accessories. The vehicle has a transfer switch which is operable to transfer a power supply to the fuse panel between the primary battery and the alternator based on a speed of the vehicle as sensed by a sensor in communication with the transfer switch.

In yet another aspect, a vehicle trailer is provided. The vehicle trailer has an axle having two hubs, and a wheel connected to each hub, a trailer body, and an alternator connected to the trailer and engaged with at least one of the axle, two hubs, and wheel or wheels. The alternator is operable to generate electricity upon a rotation of at least one of the axle, two hubs, and wheel or wheels. This alternator is in electric communication with a power strip on the trailer which has a plurality of electrical power outlets and the alternator is operable to provide electrical power to the plurality of electrical power outlets upon rotation of the wheels of the trailer. The trailer further comprises a quantity of battery powered equipment stored thereon. This battery powered equipment is plugged into at least one of the plurality of electrical outlets, such that upon a movement of the trailer, the battery powered equipment may be charged by the electricity produced by the alternator.

### BRIEF DESCRIPTION OF DRAWINGS

FIG. 1 provides a view of an embodiment of a vehicle and trailer assembly contemplated herein.

FIG. 2 provides a detail view of an embodiment of a trailer contemplated herein.

FIG. 3 provides a side view of an embodiment of a vehicle trailer contemplated herein.

FIG. 4 provides a side view of an embodiment of a vehicle contemplated herein.

FIG. 5 provides an embodiment of a schematic view of electrical flow and related components, as contemplated herein.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a vehicle trailer which has an alternator for converting rotational kinetic energy of the trailer wheel or axle into electricity. This electricity may then be used to provide power directly to an electric vehicle battery, to the vehicle's fuse panel for powering vehicle accessory systems such as air conditioning, heat, lights, vehicle computer, power windows, locks, cigarette lighter and other power plugs, audio system, communication systems, battery management system and battery conditioning components, and the like, may provide power to the vehicle's 12 volt battery, to a separate battery pack for later use, and/or to an electrical outlet or outlets, among other options and combinations. While the primary embodiments herein are discussed with respect to a vehicle trailer, other embodiments may integrate the features onto the vehicle itself, such as one or more alternators connecting to a rear axle or wheel of a vehicle, with components connected to the vehicle itself, rather than on a trailer. In further embodiments, a larger scale system may be implemented on tractor trailers.

By implementing the system on a trailer, multiple advantages are achieved including the ability to carry additional loads and equipment, additional sources of rotational energy (the wheels and/or axles), offsetting the added drag when an electric vehicle is pulling a trailer, providing added mass which can increase the energy gathered during deceleration and downhill in particular, as well as a convenient structure for storing electrically powered devices, batteries, power outlets, and the like. In a particular embodiment, the power outlet may be a NEMA 5-15 outlet operating at 120 volt at 15 Amperes as provided by the alternator (or via a battery charged by the alternator, or a power converter). In a further embodiment, the trailer may comprise an onboard battery which is charged by the alternator. The battery may in turn provide electrical power to the power outlets either exclusively or as a supplemental source of electricity when the alternator is not sufficiently powering the power outlets.

The presently disclosed system utilizes an alternator to generate current from the kinetic (rotational) energy of wheels or an axle. The wheels or axle are, in most embodiments, on a trailer which is pulled by a vehicle. In one embodiment, the generated electricity may be sent to an electric vehicle (“EV”) primary battery, thereby providing an additional charge to the vehicle battery. In another embodiment, the generated electricity may be directed to the 12 volt battery of the vehicle, in addition to or instead of the primary battery. In further embodiments, electricity generated by the alternator may be directed to a power outlet or outlets, which allow electrical devices, machines, batteries, and the like to be charged while the trailer is in motion. It is to be understood that various embodiments may be combined with other embodiments without straying from the scope of this disclosure.

In some embodiments, the alternator may be connected to the trailer system, or directly to a vehicle wheel, axle, hub, or the like. The alternator, in these embodiments, may be used to provide electricity to some or all of the vehicle's electrical accessories (heating and air conditioning, vehicle sensors and meters, power controls and displays, battery management system, lights, power outlets and cigarette lighter, battery conditioning units such as battery fans and heaters, battery management system, and the like), rather than drawing power for them from the vehicle's primary battery. As such, the vehicle battery is used more directly for driving the vehicle. In such embodiments, other vehicle batteries such as a traditional 12 volt lead acid battery may also be charged by the alternator. In such embodiments, the vehicle's primary battery may be entirely disconnected from the fuse panel of the vehicle, or may be connected to the fuse panel by a transfer switch. In a further embodiment, the vehicle may be equipped with two or more alternators, with one providing electricity to the vehicle's accessory fuse panel (and in turn, vehicle accessories) and another providing electricity directly to the vehicle's primary battery. Using the alternator of the trailer to provide power to the fuse panel and in turn to power vehicle accessory systems is typically described herein for electric vehicles, but it should be understood that the same system may be used on an internal combustion engine vehicle and is also able to increase fuel efficiency even in an internal combustion vehicle.

As is known in the art, the alternator requires vehicle movement to generate electricity. Therefore, if the vehicle is stopped or moving slowly, it will not produce electricity. Accordingly, in some embodiments, a transfer switch may be used to switch power sources going to the fuse panel to power the vehicle's electrical accessories between the primary battery (or other battery), and the alternator. In one embodiment, this may be a DC to DC transfer switch to control DC flow from the alternator and DC flow from the primary battery (or other vehicle on board battery). In typical embodiments, this DC to DC transfer switch is operable at high amperage, such as greater than 30 amps, to accommodate high electrical flow rates from both battery and alternator. When the vehicle is moving fast enough, the switch causes the vehicle's electrical systems to draw power from the alternator. When the vehicle is stopped or moving below a predetermined threshold speed (such as 10, 15, 20, 25 mph, and the like), the transfer switch causes the accessories to draw power from the primary battery so as not to interrupt or interfere with the vehicle's power systems. A sensor for detecting this speed is in communication with the switch, such as a speed sensor, a sensor measuring electrical output by the alternator, and the like. In a particular embodiment, the electrical system may monitor the power generated from the alternator and, if the voltage, amperage, and/or wattage varies or decreases below a predetermined level, the vehicle's primary battery may provide supplemental power. Such a system may vary the electrical flow to the vehicle's fuse panel based on electric draw of the systems and vehicle speed. Again, such an alternator may be connected to a vehicle trailer pulled by the vehicle, or may be on the vehicle itself. In a particular embodiment, an alternator may be a 300-amp, 18 volt alternator, but of course may vary depending on vehicle, targeted accessories to power, and the like. In certain embodiments, the alternator on the trailer or vehicle may have a manual power on/off switch to activate or deactivate the alternator to prevent unintended power draw when not in use.

Turning to certain trailer embodiments, it may be advantageous to utilize the alternator on the trailer as a supplemental braking system to generate excess power by the alternator when the vehicle is decelerating. Common trailer to vehicle connections include a connector which powers and activates brake lights when vehicle brakes are applied. In such embodiments, a controller may communicate with this braking signal coming from the vehicle to activate the alternator and/or adjust the amount of energy the alternator will extract from the rotating wheels (i.e. how much rotational energy the alternator will extract). This will provide additional braking to the vehicle, limiting break wear and tear, and also will capture waste energy generated during braking. In a further similar embodiment, the trailer may include an incline sensor. The incline sensor may identify when the vehicle is travelling downhill. When identified, the alternator and/or its control system may be actuated to draw additional power from the spinning wheels, through various approaches including, but not limited to gearing, belt control, pulleys, and the like. The additional power draw when moving downhill reduces strain on the vehicle brakes and provides more even braking application. Notably, trailer embodiments which use on board power utilization (such as the embodiments discussed where the alternator electricity is used to power battery powered equipment on the trailer and/or having a power bank on the trailer) may be useful for both electric vehicle as well as traditional internal combustion vehicles as well.

While the term alternator is used to describe the device which generates electricity via the rotational energy of the wheel/axle, it should be understood that any device which is able to generate electricity in this manner is also contemplated herein.

In yet another embodiment, which may be applied with the various embodiments and disclosures herein, the trailer may further comprise an electrical motor operable to drive the wheels of the trailer. The motor in this embodiment is in communication with the alternator and/or a battery on the trailer. In conditions where there is excess electricity having been gathered by the alternator via, e.g. braking, the electricity may then be later applied as output to the motor, increasing efficiency. In certain cases, the alternator may be operable as an electric motor when run in reverse, and thus the alternator and motor may be integrated.

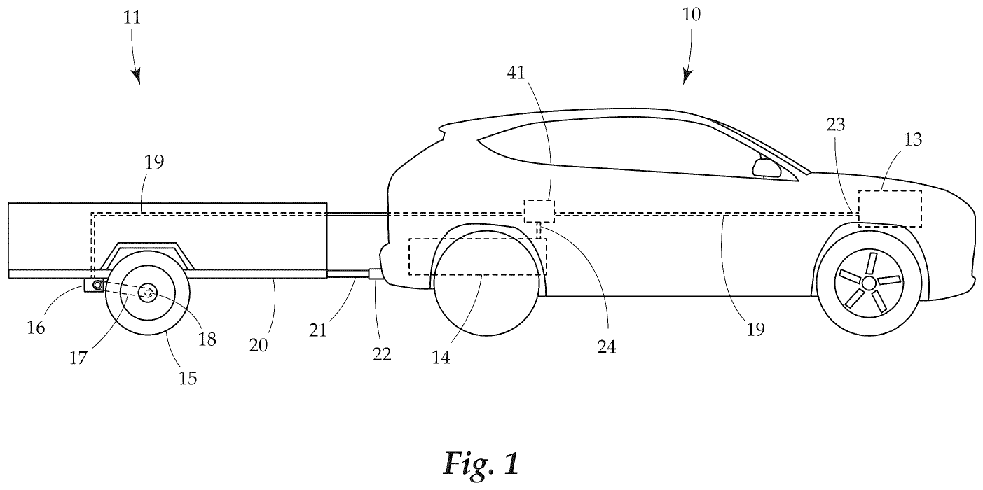

Turning now to FIG. 1, a vehicle and trailer system is provided. The vehicle 10 has a trailer 11 connected thereto. In this embodiment, the vehicle is an electric vehicle, but in other embodiments, the trailer may be connected and used with an internal combustion vehicle as well. The vehicle 10 has a primary battery 14 and a fuse panel 13. A switch 41 is connected to both alternator power wiring 19 and main battery power wiring 24, and is operable to switch electric flow to the fuse panel 13 at junction 23, and in turn to power vehicle accessories. Switching by the switch 41 controls power sources between the alternator of the trailer 16 and main battery 14 depending on vehicle operational conditions (i.e. if the alternator is providing sufficient power to operate the accessories).

The trailer 11 of the system is connected to the vehicle via tongue 21 and hitch 22. The trailer 11 has a body 20 which provides the structure of the trailer. An alternator 16 is operable to generate electricity based on a movement of wheel 15 as it is pulled by the vehicle 10. The wheel 15 is supported by axle 18 and a rotation of either causes a rotation of a belt 17 which joins the wheel, hub, or axle to the alternator such that a spinning of the wheel 15 causes a spinning of alternator 16 components. This in turn generates electricity. The alternator 16 is connected to the vehicle via wiring 19 which, in typical embodiments, can be removably connected to the vehicle via a plug.

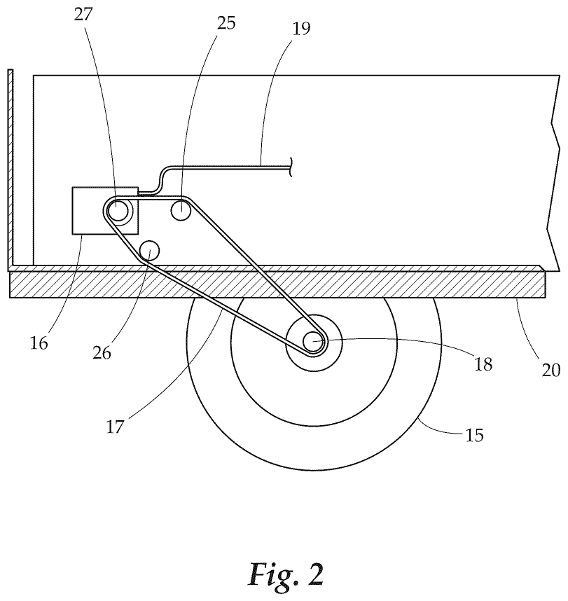

FIG. 2 provides a detail view of the alternator mounted to the trailer. Trailer axles are typically supported by a suspension system which allows the wheels to absorb shocks and travel over uneven roads without extreme vibration or shock, leading to damage and lack of control. The suspension system also compresses more when the trailer is under load compared to when it is unloaded. This results in a movement of the wheel 15 relative to the trailer body 20, which must be accommodated for with respect to the belt or chain connection between the wheel and alternator. To accommodate for this movement, the present disclosure may use a tensioner which maintains consistent tension on the belt. In the embodiment shown, the tensioner involves a plurality of pulleys 26, 25 which are mounted on arms which can pivot to accommodate for movement. Typically, the arms are spring loaded to bias the arms, and in turn pulleys, 25, 26 in a direction to apply tension to the belt 17. The belt 17 in turn is able to engage with the wheel 27 on the alternator 16 and rotate it based on movement of the wheel 15 even when the trailer is operating in conditions which activate the suspension system.

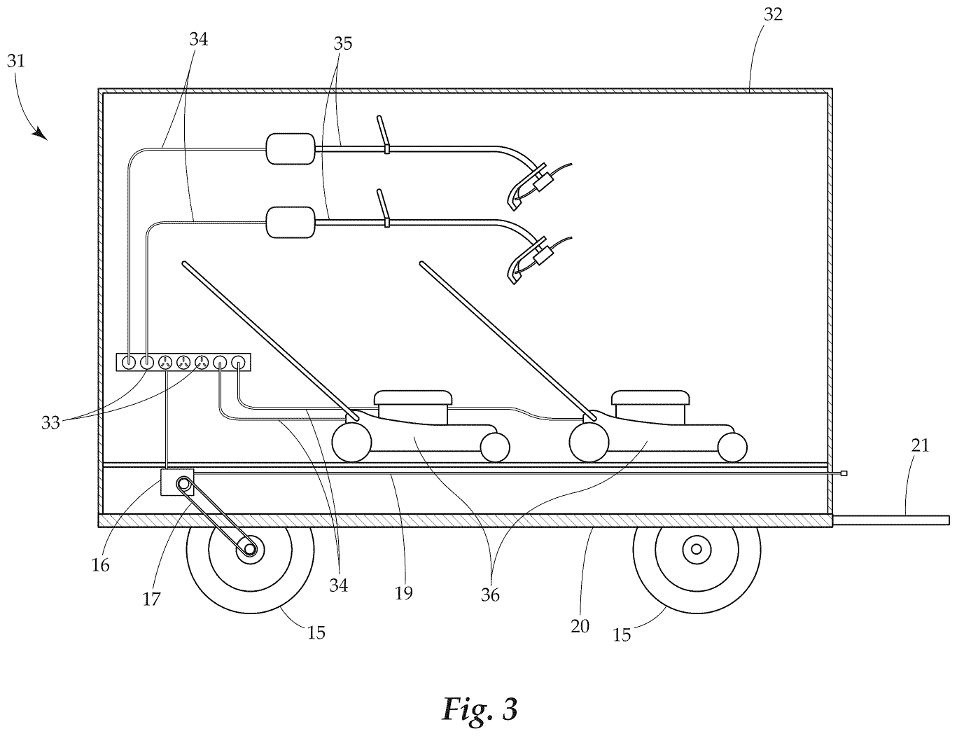

FIG. 3 shows another embodiment of a trailer system which uses the alternator system to provide on board electrical power to a power strip of power outlets on the trailer for charging and other power use. Here, trailer 31 has a body 20, wheels 15 and a tongue 21 for connection to the vehicle (not shown). Alternator 16 connects to wheel 15, or a component thereof, via belt 17 to generate electricity when the wheel 15 rotates. The alternator connects electrically to both the electrical outlet strip 33 as well as, in this embodiment, an optional a power output wiring 19 which is connectable to a vehicle. The trailer 31 is enclosed by housing enclosure 32. Within the trailer enclosure 32 are multiple batter powered equipment. In this case, the equipment is electric lawnmowers 36 and trimmers 35. Other battery powered equipment may of curse also be stored in the trailer. However, the present system may be particularly useful for charging battery powered equipment used by workers in remote locations, particularly as more climate regulations are enacted which require the use of battery powered equipment over fossil fuels. The equipment is plugged into the power strip 33 via plugs 34. As such, when the trailer is moved, such as from job site to job site, the batteries of the equipment are charged, allowing for efficient work and ensuring that the batteries remain in a charged, operable state even when in remote locations without electrical infrastructure or accessible outlets.

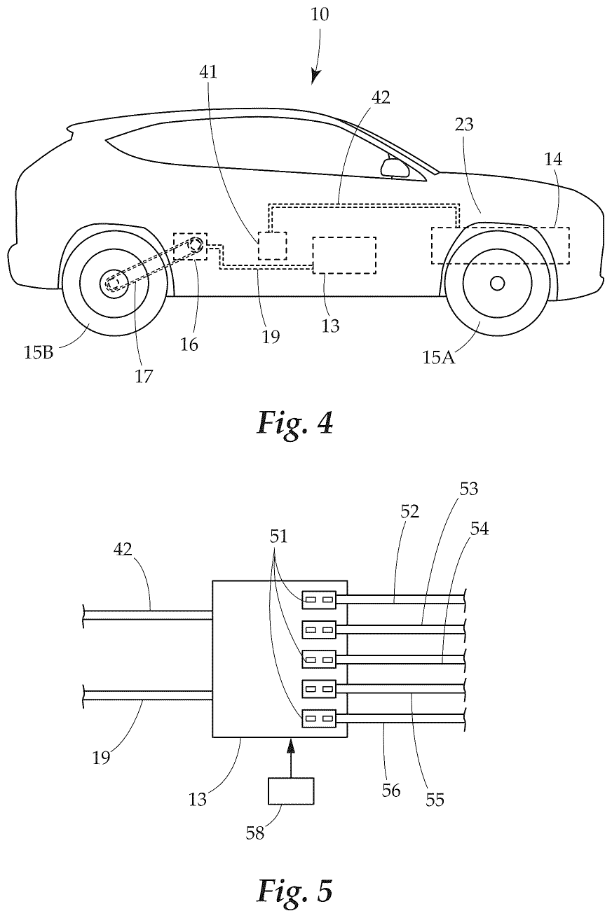

FIG. 4 provides a view of a vehicle having an alternator thereon to provide electrical power to the vehicle fuse panel and, in turn, accessory systems. In this embodiment, the alternator 16 is positioned on the vehicle 10, engaged with the rear wheels 15B or axle(s), via a belt 17, chain or the like. Wiring 19 connects alternator 16 to a transfer switch 41 and in turn to the fuse panel 13 which provides power to various vehicle accessory system. A wiring from the electric vehicle's primary battery 14 also connects to transfer switch 41. As noted above, at low speeds, the alternator does not produce enough electricity to provide adequate on-board power, and therefore the transfer switch 41 is operable to switch power sources between the primary battery and alternator. In certain transfer switch embodiments, the switch may be programmed and operable to combine power inputs so that the primary battery only provides supplemental electricity to the fuse panel in cases where the alternator is providing some, but not enough electricity. In other words, the transfer switch 41 may allow for electricity to come from both the alternator and primary battery at the same time to power the fuse panel and in turn vehicle accessories.

FIG. 5 provides a schematic view of the connections relating to the fuse panel of the vehicle. Electrical power input to transfer switch 41 from the alternator connects via wiring 19 and from the main battery connects via wiring 42. A sensor 58 such as a speed sensor, electrical sensor connected to the alternator, and the like, is in communication with switch 41 and switch 41 is programmed to control or switch electrical input to the fuse panel based on input from the sensor 58. Wiring 57 connects to the fuse panel 13 which directs electrical power via fuses 51 to various electrical accessories 52-57.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. An electric vehicle and trailer assembly comprising:
an electric vehicle having a primary battery operable to provide power to an electric drive motor;
and a fuse panel controlling power to vehicle accessory electronic systems;
a trailer connected to the vehicle, the trailer comprising an axle having two hubs, and a wheel connected to each hub, a trailer body, and an alternator connected to the trailer and engaged with at least one of the axle, two hubs, and wheel or wheels;
wherein the alternator is operable to generate electricity upon a rotation of at least one of the axle, two hubs, and wheel or wheels, and wherein the alternator is in electric communication with at least one of the fuse panel and the primary battery to provide electrical power to at least one of the fuse panel and the primary battery.

2. The electric vehicle and trailer assembly of claim 1 wherein the alternator is in electric communication with the fuse panel.

3. The electric vehicle and trailer assembly of claim 2 further comprising a transfer switch operable to transfer a power supply to the fuse panel between the primary battery and the alternator based on a speed of the vehicle as sensed by a sensor in communication with the transfer switch.

4. The electric vehicle and trailer assembly of claim 3 wherein the sensor is a speed sensor.

5. The electric vehicle and trailer assembly of claim 3 wherein the sensor is an electrical sensor detecting power generation from the alternator.

6. The electric vehicle and trailer assembly of claim 1 wherein the trailer comprises a power strip of a plurality of electrical power outlets powered by the alternator.

7. The electric vehicle and trailer assembly of claim 6 wherein the electrical power outlets are each a NEMA 5-15 outlet and wherein the alternator provides 120 volt at 15 Amperes.

8. The electric vehicle and trailer assembly of claim 6 further comprising battery powered equipment, the battery powered equipment plugged into at least one of the plurality of electrical outlets, such that upon a movement of the trailer, the battery powered equipment may be charged.

9. The electric vehicle and trailer assembly of claim 8 wherein the battery powered equipment is a lawnmower, hedge clippers, or a trimmer.

10. The electric vehicle and trailer assembly of claim 8 wherein the trailer further comprising a trailer battery connected to the alternator, and the trailer battery connected to the electrical power outlets to provide electricity to the electrical power outlets.

11. The electric vehicle and trailer assembly of claim 10 wherein the trailer further comprising an electric motor operable to drive the wheels of the trailer using electricity from the trailer battery upon an input from a trailer battery sensor.

12. The electric vehicle and trailer assembly of claim 11 wherein the electric motor is integrated with the alternator.

13. The electric vehicle and trailer assembly of claim 1 further comprising a brake sensor operable to identify that brakes of the vehicle are being applied, and to cause the alternator to activate when the brakes of the vehicle are being applied.

14. The electric vehicle and trailer assembly of claim 1 further comprising a sensor operable to identify that the vehicle is operating on a downhill grade, and to cause the alternator to activate when the vehicle is operating on the downhill grade.

15. The electric vehicle and trailer assembly of claim 1 further comprising a second alternator, wherein the alternator is in electric communication with the fuse panel, and wherein the second alternator is in communication with the primary battery for charging the primary battery.

16. The electric vehicle and trailer assembly of claim 2 wherein the vehicle accessory electronic systems comprising an air conditioner, heater, on board computer, power windows, and battery conditioning units.

17. An electric vehicle comprising:
a primary battery operable to provide power to an electric drive motor; and a fuse panel controlling power to vehicle accessory electronic systems;
an alternator engaged with at least one of an axle, two hubs, and wheel or wheels of the electric vehicle;
wherein the alternator is operable to generate electricity upon a rotation of at least one of the axle, two hubs, and wheel or wheels, and wherein the alternator is in electric communication with the fuse panel provide electrical power to the fuse panel;
wherein the primary battery is in communication with the fuse panel, and the vehicle comprising a transfer switch operable to transfer a power supply to the fuse panel between the primary battery and the alternator based on a speed of the vehicle as sensed by a sensor in communication with the transfer switch.

18. The electric vehicle of claim 17 wherein the sensor is a speed sensor.

19. The electric vehicle of claim 17 wherein the vehicle accessory electronic systems comprising an air conditioner, heater, on board computer, power windows, and battery conditioning units.

20. A vehicle trailer connectable to a motor vehicle comprising:
an axle having two hubs, and a wheel connected to each hub, a trailer body, and an alternator connected to the trailer and engaged with at least one of the axle, two hubs, and wheel or wheels;
wherein the alternator is operable to generate electricity upon a rotation of at least one of the axle, two hubs, and wheel or wheels, and wherein the alternator is in electric communication with a power strip comprising a plurality of electrical power outlets and is operable to provide electrical power to the plurality of electrical power outlets; and
a quantity of battery powered equipment stored by the trailer, the battery powered equipment plugged into at least one of the plurality of electrical outlets, such that upon a movement of the trailer, the battery powered equipment may be charged.
